(19) United States
(12) Patent Application Publication
(10) Pub. No.: US 2026/0269974 A1
(43) Pub. Date: Sep. 10, 2026

(54) WIRELESS COMMUNICATION METHOD AND COMMUNICATION DEVICE

(71) Applicant: GUANGDONG OPPO MOBILE TELECOMMUNICATIONS CORP., LTD., Dongguan (CN)

(72) Inventors: Yapu LI, Dongguan (CN); Chaoming LUO, Dongguan (CN); Ning GAO, Dongguan (CN); Liuming LU, Dongguan (CN)

(21) Appl. No.: 19/661,287

(22) Filed: Apr. 28, 2026

Related U.S. Application Data
(63) Continuation of application No. PCT/CN2023/134375, filed on Nov. 27, 2023.

(51) Int. Cl. H04L 1/00

(52) U.S. Cl. CPC H04L 1/0007

(57) ABSTRACT

A wireless communication method and a communication device are provided. The method includes that: a first device transmits a first physical layer protocol data unit (PPDU), here, the first PPDU includes a preamble and/or a packet extension (PE) field, and when the first PPDU is transmitted using a distributed resource unit (dRU), tones occupied by the preamble and/or the PE field satisfy a first rule.

### CROSS-REFERENCE TO RELATED APPLICATION(S)

This application is a continuation of International Application No. PCT/CN2023/134375 filed on Nov. 27, 2023, the entire contents of which are hereby incorporated by reference in its entirety.

### RELATED ART

With the development of technology, a resource unit (RU) can have not only contiguous tones, but also non-contiguous tones. An RU with contiguous tones may be referred to as a regular RU (rRU). An RU with non-contiguous tones may be referred to as a distributed RU (dRU). For transmission of some fields in a physical layer protocol data unit (PPDU) in a dRU mode, the related technology has not provided an appropriate solution.

### SUMMARY

The present disclosure relates to the field of communication technologies, and provides a wireless communication method and a communication device.

In a first aspect, a wireless communication method is provided. The method includes that: a first device transmits a first PPDU. Here, the first PPDU includes a preamble and/or a packet extension (PE) field; and in a case where the first PPDU is transmitted using a dRU, tones occupied by the preamble and/or the PE field satisfy a first rule.

In a second aspect, a wireless communication method is provided. The method includes that: a second device receives a first PPDU transmitted by a first device. Here, the first PPDU includes a preamble and/or a PE field; and in a case where the first PPDU is transmitted using a dRU, tones occupied by the preamble and/or the PE field satisfy a first rule.

In a third aspect, a communication device is provided. The communication device is a first device. The communication device includes a processor and a memory. The memory is configured to store one or more computer programs that, when executed by the processor, cause the communication device to transmit a first PPDU. Here, the first PPDU includes a preamble and/or a PE field; and in a case where the first PPDU is transmitted using a dRU, tones occupied by the preamble and/or the PE field satisfy a first rule.

In a fourth aspect, a communication device is provided. The communication device is a second device. The communication device includes a processor and a memory. The memory is configured to store one or more computer programs that, when executed by the processor, cause the communication device to receive a first PPDU transmitted by a first device. Here, the first PPDU includes a preamble and/or a PE field; and in a case where the first PPDU is transmitted using a dRU, tones occupied by the preamble and/or the PE field satisfy a first rule.

### BRIEF DESCRIPTION OF THE DRAWINGS

FIG. 1 is a diagram of a wireless communication system applicable to the embodiments of the present disclosure.

FIG. 2A is a diagram of a format of an extremely high throughput (EHT) multi-user (MU) PPDU.

FIG. 2B is a diagram of a format of an EHT trigger-based (TB) PPDU.

FIG. 3 is an exemplary diagram of a scenario using dRU transmission.

FIG. 4 is a flowchart of a wireless communication method provided by an embodiment of the present disclosure.

FIG. 5A is an exemplary diagram of a format of an ultra-high reliability (UHR) MU PPDU.

FIG. 5B is an exemplary diagram of a format of a UHR TB PPDU.

FIG. 6 is a structural diagram of a communication device provided by an embodiment of the present disclosure.

FIG. 7 is a structural diagram of another communication device provided by an embodiment of the present disclosure.

FIG. 8 is a structural diagram of an apparatus for communication provided by an embodiment of the present disclosure.

### DETAILED DESCRIPTION

Hereinafter, technical solutions in the present disclosure will be described with reference to the accompanying drawings.

### Communication System

The technical solutions of the embodiments of the present disclosure can be applied to various communication systems, such as wireless local area networks (WLANs), wireless fidelity (WiFi), high performance radio local area networks (HIPELANs), wide area networks (WANs), cellular networks or other communication systems. As another example, the technical solutions provided by the embodiments of the present disclosure can be applied to communication systems adopting the 802.11 standard. Exemplarily, the 802.11 standard includes, but is not limited to, the 802.11ax standard, the 802.11be standard, the next generation 802.11 standard, and the like.

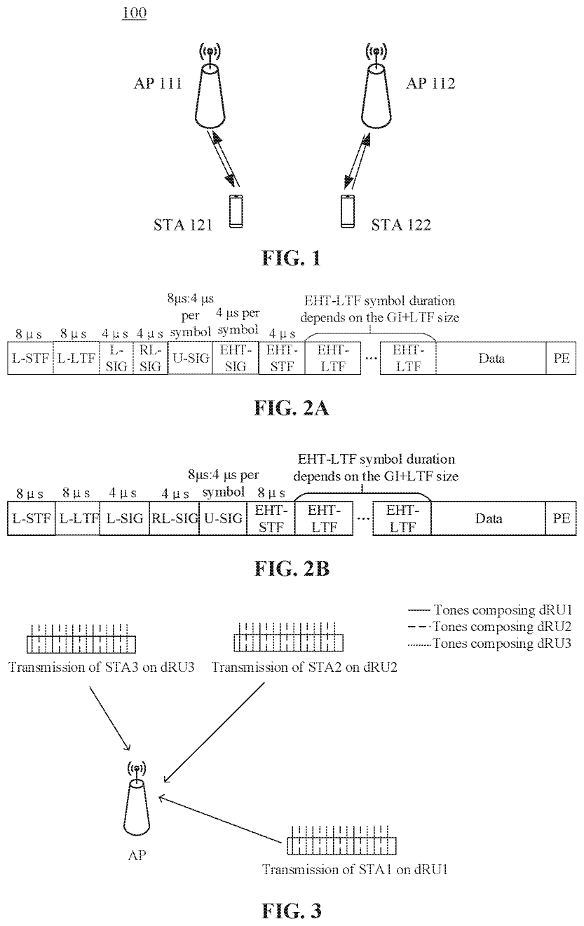

FIG. 1 illustrates a diagram of a communication system applicable to the embodiments of the present disclosure. With reference to FIG. 1, communication devices in the communication system 100 may include an access point (AP) 111, an AP 112, a station (STA) 121, and a STA 122, where the STA 121 may access the network via the AP 111, and the STA 122 may access the network via the AP 112.

In some implementations, a STA may establish association relationship(s) with one or more APs, after this, communication may be performed between the STA and the AP that have the association relationship. With reference to FIG. 1, the AP 111 and the STA 121 may communicate after establishing the association relationship, and the AP 112 and the STA 122 may communicate after establishing the association relationship.

In some implementations, the communication in the communication system 100 may be a communication between an AP and a non-AP STA, a communication between a non-AP STA and a non-AP STA, or a communication between a STA and a peer STA. Here, the peer STA may refer to a device at the other end of the communication link with the STA, for example, the peer STA may be an AP or a non-AP STA.

It should be understood that FIG. 1 exemplarily illustrates two AP STAs and two non-AP STAs, and that the communication system 100 may also include a larger number of AP STAs or the communication system 100 may include other numbers of non-AP STAs, which are not limited by the embodiments of the present disclosure.

Further, the above-described communication system can be applied to a scenario of multi-device coordination, such as multi-AP (multiple access points) coordination, or multi-STA coordination.

In the embodiments of the present disclosure, the names of AP and/or STA are not limited. In some scenarios, the AP may also be referred to as an AP STA. That is, in a sense, the AP is also a STA. In other scenarios, the STA may also be referred to as a non-AP STA.

In some scenarios, the above-described communication device may also be a “multi-link device (MLD)”, that is, a device that can communicate over multiple communication links, here, the multiple communication links may include communication links in different frequency bands, for example, may include a millimeter wave band and/or a low frequency band. Generally, if the multi-link device is an AP, the AP may also be referred to as a “multi-link AP”. If the multi-link device is a STA, the STA may also be referred to as a “multi-link STA”.

In the embodiments of the present disclosure, the AP may be a device in a wireless network. The AP may be a communication entity such as a communication server, a router, a switch, or a network bridge. Or, the AP device may include various forms of macro base stations, micro base stations, relay stations, or the like. Of course, the AP may also be a chip or circuit or processing system in these various forms of devices, thereby realizing the methods and functions of the embodiments of the present disclosure. AP devices can be applied to a variety of scenarios, such as sensor nodes in smart cities (e.g., smart water meters, smart electricity meters, smart air detection nodes), smart devices in smart homes (e.g., smart cameras, projectors, displays, TVs, stereos, refrigerators, washing machines), nodes in the internet of things, entertainment terminals (e.g., wearable devices AR and VR), smart devices in smart offices (e.g., printers, projectors), telematics devices in internet of vehicles, some infrastructure facilities in daily life scenes (e.g., vending machines, self-service navigation kiosks in supermarkets, self-checkout devices, self-service ordering machines), and the like.

In some implementations, the role of the STA in the communication system is not absolute. In some scenarios, the STA may act as an AP. For example, when a mobile phone connects to a router, the mobile phone may be a non-AP STA, while when the mobile phone serves as a hotspot for other mobile phones, the mobile phone acts as an AP.

In the embodiments of the present disclosure, the STA device may be a device having a wireless transceiver function. For example, it may support the 802.11 family of protocols, and may communicate with an AP or other STAs. For example, the STA is any user communication device that allows a user to communicate with the AP and thereby with a WLAN. The STA device is, for example, user equipment (UE), a mobile station (MS), a mobile terminal (MT), an access terminal, a subscriber unit, a subscriber station, a mobile equipment, a remote station, a remote terminal, a mobile device, a user terminal, a terminal, a wireless communication device, a user agent or a user apparatus, or the like.

The STA in the embodiments of the present disclosure may also be a device that provides voice/data connectivity to a user, for example, a handheld device or in-vehicle device with a wireless connection function. Examples include: a mobile phone, a tablet, a laptop, a palm-top computer, a handheld computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in a transportation safety, a wireless terminal in a smart city, a wireless terminal in a smart home, a cellular phone, a cordless phone, a session initiation protocol (SIP) phone, a wireless local loop (WLL) station, a personal digital assistant (PDA), a handheld device with wireless communication functionality, a computing device or other processing device connected to a wireless modem, a vehicle-mounted device, a wearable device, a terminal device in a 5G network, or a terminal device in future evolved public land mobile networks (PLMN), and the like. The embodiments of the present disclosure are not limited thereto.

By way of example and not limitation, in the embodiments of the present application, the STA device may also be a wearable device. Wearable devices are also referred to as smart wearable devices, and are a general term for devices that can be worn, which are developed by intelligently designing everyday accessories using wearable technology, such as glasses, gloves, watches, clothing, and shoes. Examples include: smart watches or smart glasses, as well as devices that focus on a specific type of application function and need to be used in conjunction with other devices (e.g., smartphones), such as various smart bracelets and smart jewelry for vital sign monitoring.

In addition, in the embodiments of the present disclosure, the STA device may also be a terminal device in an internet of things (IoT) system. IoT is an important part of the future development of information technology, and its main technical feature is that articles are connected to the network through communication technology, thereby realizing an intelligent network with human-machine connectivity and thing-to-thing connectivity. In the embodiments of the present disclosure, the IoT technology can achieve massive connections, deep coverage, and terminal power-saving through, for example, narrow band (NB) technology.

Further, in the embodiments of the present disclosure, the STA device may be a device in the internet of vehicles system. The communication methods in the internet of vehicles system are collectively referred to as V2X (X stands for anything). For example, the V2X communication includes vehicle-to-vehicle (V2V) communication, vehicle-to-roadside infrastructure (V2I) communication, vehicle-to-pedestrian (V2P) communication, or vehicle-to-network (V2N) communication, or the like.

In addition, in the embodiments of the present disclosure, the STA device may also include sensors such as a smart printer, a train detector, and a gas station. Their main functions include collecting data (for some terminal devices), receiving control information and downlink data from the AP device, and sending electromagnetic waves to transmit data to the AP device.

Further, the AP device in the embodiments of the present disclosure may be a device for communicating with a STA device. The AP device may be a network device in a wireless local area network, and the AP device may be used for communicating with the STA device over the wireless local area network.

From the perspective of the communication standards supported by the AP, in some implementations, the AP may be a device supporting the 802.11be standard. The AP may also be a device supporting various current and future WLAN standards of the 802.11 family, such as 802.11ax, 802.11ac, 802.11n, 802.11 g, 802.11b, and 802.11a.

From the perspective of the communication standards supported by the STA, in some implementations, the non-AP STA may support the 802.11 be standard. The non-AP STA may also support various current and future WLAN standards of the 802.11 family, such as 802.11 ax, 802.11 ac, 802.11 n, 802.11 g, 802.11 b, and 802.11 a.

In the embodiments of the present disclosure, there is no limitation on the frequency bands that can be supported by the WLAN technology. In some implementations, the frequency bands that can be supported by the WLAN technology may include, but are not limited to, low frequency bands (e.g., 2.4 GHZ, 5 GHZ, 6 GHZ), and high frequency bands (e.g., 45 GHz, 60 GHz).

It should be understood that the embodiments of the present disclosure do not impose any specific limitation on the specific forms of STA devices and AP devices, and the descriptions herein are merely illustrative examples.

### EHT PPDU

The format of a PPDU is described below by taking an EHT PPDU as an example.

FIG. 2A is a diagram of the format of an EHT MU PPDU. The EHT MU PPDU is used to transmit data to one or more users. The EHT MU PPDU illustrated in FIG. 2A is not used to respond to a trigger frame. As illustrated in FIG. 2A, the EHT MU PPDU may include: a non-HT short training field (L-STF), a non-HT long training field (L-LTF), a non-HT signal (L-SIG), a repeated L-SIG (RL-SIG), a universal signal (U-SIG), an EHT-SIG, an EHT-STF, an EHT-LTF, a data field, and a PE field.

FIG. 2B is a diagram of the format of an EHT TB PPDU. The EHT TB PPDU can be used to respond to a trigger frame from an AP. As illustrated in FIG. 2B, the EHT TB PPDU may include: an L-STF field, an L-LTF field, an L-SIG field, an RL-SIG field, a U-SIG field, an EHT-STF field, an EHT-LTF field, a data field, and a PE field.

As can be seen from FIGS. 2A and 2B, the EHT-SIG field is present in the EHT MU PPDU, while the EHT-SIG field is absent in the EHT TB PPDU. The duration of the EHT-STF field in the EHT TB PPDU is twice that of the EHT-STF in the EHT MU PPDU.

The L-STF, L-LTF, L-SIG, RL-SIG, U-SIG, and EHT-SIG fields may all be referred to as pre-EHT modulated fields. The EHT-STF, EHT-LTF, data, and PE fields may all be referred to as EHT modulated fields.

In the EHT TB PPDU, the pre-EHT modulated field (including L-STF, L-LTF, L-SIG, RL-SIG, and U-SIG fields) is transmitted only on the 20 MHz channel where the EHT modulated field of the STA is present. If the EHT modulated field of the STA occupies more than one 20 MHz channel, the pre-EHT modulated field is duplicated on all 20 MHz channels where the EHT modulated field is present.

When the PPDU bandwidth is greater than 20 MHZ, the L-STF, L-LTF, L-SIG, RL-SIG, and U-SIG are duplicated in 20 MHz.

The following mainly describes the EHT-STF, EHT-LTF, and PE fields.

### EHT-STF

The main purpose of the EHT-STF field is to improve automatic gain control estimation in multiple-input multiple-output (MIMO) transmission. The EHT-STF field may be located after the EHT-SIG field in the EHT MU PPDU. The EHT-STF field may be located after the U-SIG in the EHT TB PPDU. The duration of the EHT-STF field in the EHT MU PPDU may be 4 μs (with a period of 0.8 μs, 5 periods). The duration of the EHT-STF field in the EHT TB PPDU is 8 μs (with a period of 1.6 μs, 5 periods).

Hereinafter, a frequency domain sequence (hereinafter referred to as a sequence) of the EHT-STF in the EHT MU PPDU and the EHT TB PPDU will be separately described.

### (1) EHT MU PPDU

For a 20 MHz transmission, the frequency domain sequence of the EHT-STF in the EHT MU PPDU may satisfy:

$${EHTS}_{- 112 : 16 : 112} = \{ M \} \cdot \frac{1 + j}{\sqrt{2}} .$$

Here, M={−1, −1, −1, 1, 1, 1, −1, 1, 1, 1, −1, 1, 1, −1, 1}. The value at null tone index 0 is EHTS₀=0. EHTS_{a:b:c} means coefficients of the EHT-STF on every b subcarrier indices from a to c subcarrier indices, and coefficients on other subcarrier indices are set to zero.

EHTS_{-112:16:112} may denote that coefficients on every 16 subcarrier indices from −112 to 112 subcarrier indices are non-zero, and coefficients on other subcarrier indices are zero. That is, EHT-STF coefficients on subcarrier indices of −112, −96, −80, −64, −48, −32, −16, 0, 16, 32, 48, 64, 80, 96, and 112 are non-zero, and EHT-STF coefficients on other subcarrier indices are zero.

For a 40 MHz transmission, the frequency domain sequence of the EHT-STF in the EHT MU PPDU may satisfy: EHTS_{-240:16:240}={M, 0, −M}·(1+j)\sqrt{2}.

For a 80 MHz transmission, the frequency domain sequence of the EHT-STF in the EHT MU PPDU may satisfy: EHTS_{-496:16:496}={M, 1, −M, 0, −M, 1, −M}. (1+j)\sqrt{2}.

For a 160 MHz transmission, the frequency domain sequence of the EHT-STF in the EHT MU PPDU may satisfy:

$${EHTS}_{- 1008 : 16 : 1008} = \{ M , 1 , - M , 0 , - M , 1 , - M , 0 , - M , - 1 , M , 0 , - M , 1 , - M \} \cdot ( 1 + j ) / \sqrt{2} .$$

For a 320 MHz transmission, the frequency domain sequence of the EHT-STF in the EHT MU PPDU may satisfy:

$${EHTS}_{- 2 \; 032 : 16 : 2032} = \{ M , 1 , - M , 0 , - M , 1 , - M , 0 , M , 1 , - M , 0 , - M , 1 , - M , 0 , - M , - 1 , M , 0 , M , - 1 , M , 0 , - M , - 1 , M , 0 , - M , - 1 , M \} \cdot ( 1 + j ) / \sqrt{2} .$$

### (2) EHT TB PPDU

For a 20 MHz transmission, the frequency domain sequence of the EHT-STF in the EHT TB PPDU may satisfy: EHTS_{-120:8:120}={M, 0, −M}. (1+j)\sqrt{2}.

For a 40 MHz transmission, the frequency domain sequence of the EHT-STF in the EHT TB PPDU may satisfy: EHTS_{-248:8:248}={M, −1, −M, 0, M, −1, M}·(1+j)\sqrt{2}. Here, the value of the EHT-STF sequence at edge tone indices±248 is EHTS_{±248}=0.

For a 80 MHz transmission, the frequency domain sequence of the EHT-STF in the EHT TB PPDU may satisfy:

$${EHTS}_{- 504 : 8 : 504} = \{ M , - 1 , M , - 1 , - M , - 1 , M , 0 , - M , 1 , M , 1 , - M , 1 , - M \} \cdot ( 1 + j ) / \sqrt{2} .$$

Here, the value of the EHT-STF sequence at edge tone indices±504 is EHTS_{±504}=0.

For a 160 MHz transmission, the frequency domain sequence of the EHT-STF in the EHT TB PPDU may satisfy:

$${EHTS}_{- 1016 : 8 : 1016} = \{ M , - 1 , M , - 1 , - M , - 1 , M , 0 , - M , 1 , M , 1 , - M , 1 , - M , 0 , - M , 1 , - M , 1 , M , 1 , - M , 0 , - M , 1 , M , 1 , - M , 1 , - M \} \cdot ( 1 + j ) / \sqrt{2} .$$

Here, the values of the EHT-STF sequence at edge tone indices±8 and ±1016 are EHTS_{±8}=0, EHTS_{±1016}=0.

For a 320 MHz transmission, the frequency domain sequence of the EHT-STF in the EHT TB PPDU may satisfy:

$${EHTS}_{- 2040 : 8 : 2040} = \{ M , - 1 , M , - 1 , - M , - 1 , M , 0 , - M , 1 , M , 1 , - M , 1 , - M , 0 , M , - 1 , M , - 1 , - M , - 1 , M , 0 , - M , 1 , M , 1 , - M , 1 , - M , 0 , - M , 1 , - M , 1 , M , 1 , - M , 0 , M , - 1 , - M , - 1 , M , - 1 , M , 0 , - M , 1 , - M , 1 , M , 1 , - M , 0 , M , - 1 , - M , - 1 , M , - 1 , M \} \cdot ( 1 + j ) / \sqrt{2} .$$

Here, the values of the EHT-STF sequence at edge tone indices ±8, ±1016, ±1032, and ±2040 are EHTS_{±8}=EHTS_{±1016}=EHTS_{±1032}=EHTS_{±2040}=0.

For EHT-STF, if coefficients in the sequence correspond to subcarrier indices that are not modulated in the data field, such as subcarriers in RUs that have no users assigned to them in orthogonal frequency division multiple access (OFDMA) or subcarriers that are punctured, then the coefficients are set to zero.

### EHT-LTF

The EHT-LTF field provides a means for the receiver to estimate the MIMO channel between the constellation mapper outputs and the receive chains. An EHT PPDU supports 3 EHT-LTF types: 1x EHT-LTF, 2x EHT-LTF, and 4x EHT-LTF, with durations of 3.2 μs, 6.4 μs, and 12.8 μs, respectively.

In a 20 MHz transmission, the 1x EHT-LTF sequence transmitted on subcarriers [−122, 122] can satisfy:

$${EHTLTF}_{- 122 , 122} = \{ 0 , 0 , - 1 , 0 , 0 , 0 , + 1 , 0 , 0 , 0 , + 1 , 0 , 0 , 0 , - 1 , 0 , 0 , 0 , + 1 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , 0 , 0 , 0 , 0 , - 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , - 1 , 0 , 0 , 0 , + 1 , 0 , 0 , 0 , - 1 , 0 , 0 , 0 , + 1 , 0 , 0 , 0 , - 1 , 0 , 0 , 0 , - 1 , 0 , 0 , 0 , - 1 , 0 , 0 , 0 , - 1 , 0 , 0 , 0 , - 1 , 0 , 0 \} .$$

In a 20 MHz transmission, the 2xEHT-LTF sequence transmitted on subcarriers [−122, 122] may satisfy:

$${EHTLTF}_{- 122 , 122} = \{ - 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , + 1 , 0 , + 1 , 0 , + 1 , 0 , + 1 , 0 , - 1 , 0 , + 1 , 0 , - 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , + 1 , 0 , - 1 , 0 , - 1 , 0 , + 1 , 0 , 0 , 0 , + 1 , 0 , - 1 , 0 , + 1 , 0 , + 1 , 0 , - 1 , 0 , + 1 , 0 , + 1 , 0 , - 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , - 1 , 0 , - 1 , 0 , + 1 , 0 , + 1 , 0 , + 1 , 0 , - 1 , 0 , - 1 , 0 , + 1 , 0 , - 1 , 0 , + 1 , 0 , + 1 , 0 , + 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , + 1 , 0 , - 1 , 0 , + 1 \} .$$

In a 20 MHz transmission, the 4x EHT-LTF sequence transmitted on subcarriers [−122, 122] can satisfy:

$${EHTLTF}_{- 122 , 122} = \{ - 1 , - 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , + 1 , + 1 , - 1 , + 1 , - 1 , + 1 , + 1 , + 1 , + 1 , - 1 , + 1 , - 1 , - 1 , + 1 , + 1 , - 1 , + 1 , + 1 , + 1 , + 1 , - 1 , - 1 , + 1 , - 1 , - 1 , - 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , - 1 , - 1 , - 1 , - 1 , + 1 , + 1 , - 1 , - 1 , - 1 , - 1 , - 1 , + 1 , - 1 , - 1 , + 1 , + 1 , + 1 , - 1 , + 1 , + 1 , + 1 , - 1 , + 1 , - 1 , + 1 , - 1 , - 1 , - 1 , - 1 , - 1 , + 1 , + 1 , + 1 , - 1 , - 1 , - 1 , + 1 , - 1 , + 1 , + 1 , + 1 , 0 , 0 , 0 , - 1 , + 1 , - 1 , + 1 , - 1 , + 1 , + 1 , - 1 , + 1 , + 1 , + 1 , - 1 , - 1 , + 1 , - 1 , 1 , + 1 , - 1 , + 1 , - 1 , + 1 , + 1 , + 1 , - 1 , + 1 , + 1 , + 1 , - 1 , - 1 , + 1 , - 1 , - 1 , - 1 , - 1 , - 1 , + 1 , + 1 , - 1 , - 1 , - 1 , - 1 , - 1 , - 1 , + 1 , - 1 , + 1 , - 1 , - 1 , - 1 , - 1 , + 1 , - 1 , + 1 , + 1 , - 1 , - 1 , + 1 , - 1 , - 1 , - 1 , - 1 , + 1 , + 1 , - 1 , + 1 , + 1 , + 1 , + 1 , + 1 , + 1 , + 1 , - 1 , + 1 , + 1 , - 1 , - 1 , - 1 , - 1 , + 1 , - 1 , - 1 , + 1 , + 1 , - 1 , + 1 , - 1 , - 1 , - 1 , - 1 , + 1 , - 1 , + 1 , - 1 , - 1 , + 1 , + 1 , + 1 , + 1 , - 1 , - 1 , + 1 , + 1 , + 1 , + 1 , + 1 , - 1 , + 1 , + 1 , - 1 , - 1 , - 1 , + 1 , - 1 , - 1 , - 1 , + 1 , - 1 , + 1 , - 1 , + 1 , + 1 \} .$$

The foregoing illustrates the case of the EHT-LTF sequences in the 20 MHz transmission. EHT-LTF sequences in other cases will not be repeatedly described in the present disclosure. For example, for the 1x EHT-LTF, 2x EHT-LTF, and 4x EHT-LTF sequences transmitted on subcarriers [−244, 244] in a 40 MHz transmission, the 1x EHT-LTF, 2x EHT-LTF, and 4x EHT-LTF sequences transmitted on subcarriers [−500, 500] in a 80 MHz transmission, the 1x EHT-LTF, 2x EHT-LTF, and 4x EHT-LTF sequences transmitted on subcarriers [−1012, 1012] in a 160 MHz transmission, and the 1x EHT-LTF, 2x EHT-LTF, and 4x EHT-LTF sequences transmitted on subcarriers [−2036, 2036] in a 320 MHz transmission, the reference may be made to the related technologies, and the present disclosure will not provide detailed descriptions here.

Exemplarily, the EHT-LTF types that can be used by the EHT MU PPDU and the EHT TB PPDU may be as illustrated in columns 2 and 4 of Table 1, respectively.

TABLE 1

| EHT-LTF type and GI | EHT MU | EHT sounding | EHT TB |
|---|---|---|---|
| duration combination | PPDU | NDP | PPDU |
| 1x EHT-LTF and | N/A | N/A | M (See |
| 1.6 μs GI | | | comments) |
| (guard interval) | | | |
| 2x EHT-LTF and | M | M | N/A |
| 0.8 μs GI | | | |
| 2x EHT-LIF and | M | M | M |
| 1.6 μs GI | | | |
| 4xEHT-LTF and | O | N/A | N/A |
| 0.8 μs GI | | | |
| 4xEHT-LTF and | M | O | M |
| 3.2 μs GI | | | |

M = mandatory
O = optional
N/A = not supported by the PPDU format
NOTE:
1x EHT-LTF and 1.6 μs GI are only allowed for uplink (UL) non-OFDMA transmission for two or more users. If a STA does not support transmission or reception of a particular PPDU format, then the M/O designation is not applicable for the transmission or reception, respectively, of that PPDU format.

It should be noted that for the EHT-LTF, if during OFDMA transmission, for subcarriers belonging to RUs that are not allocated or are punctured, as well as direct current (DC) subcarriers or null subcarriers, the corresponding values in the EHT-LTF sequence may be replaced with zero.

### PE

The PE field may provide additional receive processing time at the end of the EHT PPDU.

The PE field of duration 0 μs, 4 μs, 8 μs, 12 μs, 16 μs, or 20 μs may be present in the EHT PPDU.

It should be noted that the PE field of duration 20 μs is only allowed when one or more of the following are satisfied: an EHT MU PPDU with at least one participating STA being modulated with 4096-QAM; a 320 MHz EHT MU PPDU if the size of one of the allocated RU or MRU (multiple resource unit) is greater than 2*996; an EHT TB PPDU.

A non-AP EHT STA shall support transmission of an EHT TB PPDU with a PE field of duration up to 20 μs, and reception of an EHT MU PPDU with a PE field of duration up to 20 μs. The PE field, if present, should be transmitted with the same average power as the data field. Other than that, the content of the PE field is arbitrary. The spectrum used by the PE field should be commensurate with the locations and sizes of the occupied RU(s) or MRU(s) in the data field to minimize power leakage outside the spectrum used by the data field. For example, for a 20 MHz OFDMA EHT PPDU, if the occupied RU in the data field is a 106-tone RU, the PE would have a spectrum that is approximately 10 MHz wide.

dRU

With the development of technology, power spectral density (PSD) limitations are tougher. For example, in 6 GHz bands, for a non-AP STA in low power indoor (LPI) bands, the PSD limitation is-1 dBm/MHz.

The rRU has contiguous tones. The transmit power per tone of the rRU is low. This is because the PSD limitation is defined by per MHz and for each STA, and since the tones in the rRU are continuous, the number of tones per MHz is large, resulting in that the transmit power per tone is low according to the PSD limitation.

The dRU has non-contiguous tones. In the case of the dRU, the number of tones per MHz is small, even just one tone per MHz, so the tones in the dRU can be transmitted with higher power compared to the rRU. For example, for a 52-tone dRU over 80 MHZ, there can be just one tone per MHz. But for a 52-tone rRU, there are about 13 tones per MHz. PSD limitation is-1 dBm/MHz in 6 GHz LPI bands. Therefore, for a 52-tone RU (about 4 MHz), the maximum transmit power allowed using rRU is only about 6 dBm, and using dRU can boost transmit power by 11 dB. This significant transmit power boost can enable higher modulation and coding scheme (MCS) or reach longer range.

As illustrated in FIG. 3, STA1, STA2, and STA3 can all boost their transmit power by using dRU. Compared to using the same size rRU, all the tones get higher transmit power and therefore the overall spectrum efficiency is enhanced significantly.

It should be noted that the MRU may include non-contiguous tones, i.e., dMRU. The technical solutions related to the dRU provided in the present disclosure can also be applied to the dMRU. For convenience of description, only the dRU will be described below as an example. If it is necessary to apply the embodiments described below to the dMRU, “dRU” may be replaced with “dMRU”

Therefore, in the case where the PPDU is transmitted using dRU, the data field may be transmitted using dRU, but the related art have not proposed how to transmit the fields other than the data field.

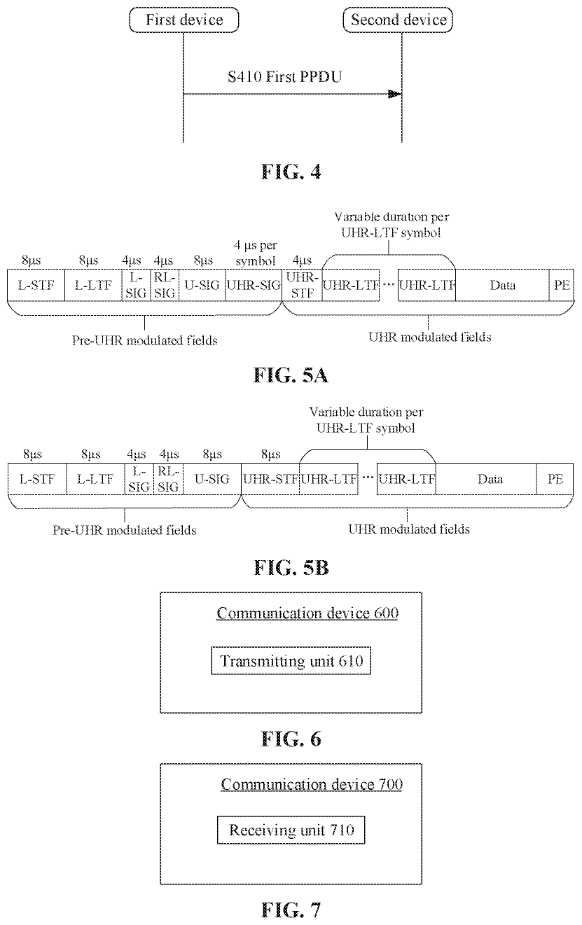

FIG. 4 is a flowchart of a wireless communication method provided by an embodiment of the present disclosure, to solve the above problems.

The method illustrated in FIG. 4 may be performed by a first device and a second device. The first device may be an AP or a non-AP STA described above. The second device may be a non-AP STA or an AP.

The method illustrated in FIG. 4 may include an operation S410.

The operation S410: the first device may transmit a first PPDU to the second device.

The first PPDU may include a preamble and/or a PE field. The preamble may include, for example, one or more of the following fields: L-STF, L-LTF, L-SIG, RL-SIG, U-SIG, UHR-SIG, UHR-STF, UHR-LTF.

The first PPDU may be transmitted using dRU. The first PPDU is transmitted using dRU, which may mean that a data field of the first PPDU is transmitted using dRU.

The first PPDU may be a trigger-based PPDU. For example, the first PPDU may be a UHR TB PPDU. The first PPDU may be a non-trigger-based PPDU, that is, the first PPDU is not a trigger-based PPDU. For example, the first PPDU may be a UHR MU PPDU.

In a case where the first PPDU is a non-trigger-based PPDU, the first PPDU is transmitted using dRU, which may include that: an RU indicated by an RU allocation field is a dRU. In a case where the first PPDU is a trigger-based PPDU, the first PPDU is transmitted using dRU, which may include that: an RU indicated by an RU allocation field in a UHR variant user info field, an uplink bandwidth (UL BW) field in a common info field, and an uplink bandwidth extension (UL BW extension) in a special user info field in a trigger frame is a dRU.

When the first PPDU is transmitted using dRU, tones occupied by the preamble and/or the PE field may satisfy a first rule.

Based on the first rule, when the first PPDU is transmitted using dRU, how the preamble and/or the PE field are transmitted can be determined. Therefore, the present disclosure improves the operating mode of the preamble and/or the PE field when the PPDU is transmitted using dRU.

The first PPDU may be a UHR PPDU. The UHR PPDU may include two formats: UHR MU PPDU and UHR TB PPDU. If the UHR PPDU is not a response to a trigger frame, the format of the UHR PPDU may be a UHR MU PPDU. That is to say, the UHR MU PPDU is a non-trigger-based PPDU. If the UHR PPDU is a response to a trigger frame, the format of the UHR PPDU may be a UHR TB PPDU. That is to say, the UHR TB PPDU format may be used in response to transmission of the trigger frame from the AP, that is, the UHR TB PPDU is a trigger-based PPDU.

The UHR MU PPDU format may be used to transmit signals to one or more users. FIG. 5A is an exemplary diagram of the format of a UHR MU PPDU. As illustrated in FIG. 5A, the UHR MU PPDU may include: an L-STF field, an L-LTF field, an L-SIG field, an RL-SIG field, a U-SIG field, a UHR-SIG field, a UHR-STF field, a UHR-LTF field, a data field, and a PE field.

As illustrated in FIG. 5A, in the UHR MU PPDU, the L-STF, L-LTF, L-SIG, RL-SIG, U-SIG, and UHR-SIG may be referred to as pre-UHR modulated fields. The UHR-STF, UHR-LTF, data, and PE fields may be referred to as UHR modulated fields.

FIG. 5B is an exemplary diagram of the format of a UHR TB PPDU. As illustrated in FIG. 5B, the UHR TB PPDU may include: an L-STF field, an L-LTF field, an L-SIG field, an RL-SIG field, a U-SIG field, a UHR-STF field, a UHR-LTF field, a data field, and a PE field.

As illustrated in FIG. 5B, in the UHR TB PPDU, the L-STF, L-LTF, L-SIG, RL-SIG, and U-SIG fields may be referred to as pre-UHR modulated fields. The UHR-STF, UHR-LTF, data, and PE fields are referred to as UHR modulated fields.

For a UHR PPDU, each UHR-LTF symbol may have the same GI duration as each data symbol, which may be 0.8 μs, 1.6 μs, or 3.2 μs. The UHR-LTF field may include three types: 1x UHR-LTF, 2x UHR-LTF, and 4x UHR-LTF. The duration of each 1x UHR-LTF symbol without GI, the duration of each 2x UHR-LTF symbol without GI, or the duration of each 4x UHR-LTF symbol without GI may be 3.2 μs, 6.4 μs, or 12.8 μs, respectively. Here, the data symbol without GI is 12.8 μs.

It should be noted that the formats of the UHR PPDU described above are merely examples. The formats of the UHR PPDU may be different from that of FIGS. 5A and 5B. In addition, the first PPDU may be another type of PPDU, and the present disclosure is not limited thereto.

Hereinafter, the first rule will be described in detail.

In some embodiments, the preamble may include a pre-modulated field. The pre-modulated field may include, for example, the pre-UHR modulated field(s) described above. For example, when the first PPDU is a UHR MU PPDU, the pre-modulated field may include one or more of the following fields: L-STF, L-LTF, L-SIG, RL-SIG, U-SIG, and UHR-SIG. For another example, when the first PPDU is a UHR TB PPDU, the pre-modulated field may include one or more of the following fields: L-STF, L-LTF, L-SIG, RL-SIG, and U-SIG.

The first rule may include that: the pre-modulated field is transmitted using contiguous tones. The transmission using contiguous subcarriers may be in a transmission manner specified in the related technologies. For example, the pre-modulated field may be transmitted using a transmission manner defined in IEEE 802.11 be.

In some embodiments, the pre-modulated field may be transmitted on a first bandwidth. The first bandwidth may be a bandwidth over which tones used by a modulated field are distributed. Here, the modulated field may include one or more of: a data field, a UHR-STF, or a UHR-LTF.

In some embodiments, since the first PPDU is transmitted using dRU, the bandwidth over which the tones used by the modulated field are distributed is a bandwidth containing the dRU. Based on this, the first bandwidth may also be referred to as a bandwidth including the dRU.

The first bandwidth may occupy one or more 20 MHz channels. When the first bandwidth occupies multiple 20 MHz channels, the pre-modulated field may be duplicated on the first bandwidth. For example, the pre-modulated field may be duplicated on all 20 MHz channels where the modulated field is present.

In some embodiments, in a presence of unmodulated tones in the data field of the first PPDU, coefficients, for the unmodulated tones, in the frequency domain sequences of part or all of fields in the preamble are zero. Exemplarily, the unmodulated tones in the data field of the first PPDU may include one or more of: tones belonging to an unassigned dRU, null tones, punctured tones, or DC tones.

The part or all of the fields in the preamble may include, for example, a first field and/or a second field described below.

In some embodiments, the preamble may include the first field and/or the second field. The first field may be related to automatic gain control estimation in MIMO transmission. For example, the first field may be a UHR-STF. The second field may be related to MIMO channel estimation. For example, the second field may include a UHR-LTF.

Under dRU, a frequency domain sequence of the first field may be a first sequence. Under dRU, a frequency domain sequence of the second field may be a second sequence. The first sequence and/or the second sequence may satisfy the first rule. First, the first rule related to the first sequence will be described with reference to First embodiment to Third embodiment.

### First Embodiment

In some implementations, the first rule may include that: the first sequence may be determined based on a frequency domain sequence of the first field when the first PPDU is transmitted using rRU.

For example, the first sequence may be the frequency domain sequence of the first field when the first PPDU is transmitted using rRU. That is to say, for the first field under dRU, it may be consistent with the frequency domain sequence of the first field under rRU. This implementation may reuse the frequency domain sequence of the first field in the related technologies. Therefore, complexity is low and implementation is easy.

In some implementations, the first rule may include that: the first sequence may be determined based on the frequency domain sequence of the first field in the related technologies. Exemplarily, when the first sequence is a frequency domain sequence of the UHR-STF under dRU (i.e., for dRU), the first sequence may be the same as the EHT-STF sequence. Here, for the EHT-STF sequence, the reference can be made to the above descriptions.

For example, when the UHR MU PPDU is transmitted using dRU, the definitions of the UHR-STF sequences for 20 MHz, 40 MHz, 80 MHz, 160 MHz, 320 MHz may be the same as the definitions of the EHT-STF sequences used by the EHT MU PPDU for 20 MHz, 40 MHz, 80 MHz, 160 MHZ, 320 MHz, respectively (e.g., defined in IEEE 802.11 be). For another example, when the UHR TB PPDU is transmitted using dRU, the definitions of the UHR-STF sequences for 20 MHz, 40 MHz, 80 MHZ, 160 MHz, and 320 MHz may be the same as the definitions of the EHT-STF sequences used by the EHT TB PPDU for 20 MHz, 40 MHz, 80 MHz, 160 MHz, and 320 MHz, respectively (e.g., defined in IEEE 802.11 be).

In some embodiments, the first sequence and a tone plan of the dRU may satisfy the first rule. The first rule may include that: each dRU in the tone plan includes tone index(es) for which one or more coefficients in the first sequence are non-zero. It can be understood that when designing the tone plan of the dRU, it may be considered that each dRU includes at least one tone index for which coefficient(s) in the first sequence are non-zero.

For example, the tone plan may include that: tones included in the dRU may be distributed at intervals of M tones, here, M is a positive integer. For another example, the distribution manner of “tones included in the dRU may be distributed at intervals of M tones” may be adjusted to satisfy that “each dRU in the tone plan includes tone index(es) for which one or more coefficients in the first sequence are non-zero”.

Hereinafter, a possible solution of the tone plan provided by an embodiment of the present disclosure will be described.

In some embodiments, the tone plan of the dRU may be designed as follows. A 26-tone dRU is formed by taking a 26-tone rRU as the reference RU and distributing it at intervals of M tones across 20 MHz, 40 MHz, 80 MHz, 160 MHz, and 320 MHz, respectively. Here, M may be a positive integer. The 52-tone dRU may be composed of two 26-tone dRUs. The 106-tone dRU may be composed of four 26-tone dRUs and two tones. The 242-tone dRU may be composed of nine 26-tone dRUs and eight tones. The 484-tone dRU may be composed of eighteen 26-tone dRUs and sixteen tones. The 996-tone dRU may be composed of thirty-seven 26-tone dRUs and thirty-four tones. The 2*996-tone dRU may be composed of seventy-four 26-tone dRUs and sixty-eight tones.

For example, in a 20 MHz bandwidth, if the tone indices of the 26-tone rRU 1 are [−121: −96], then after distributed mapping at intervals of 9 tones, the tone indices of the 26-tone dRU 1 may be [−121, −112, −103, −94, −85, −76, −66, −57, −48, −39, −30, −21, −12, 4, 13, 22, 31, 40, 49, 58, 67, 77, 86, 95, 104, 113]. Here, [x1: y1] denotes a set of tones with indices k satisfying x1≤k≤y1. [x1: y1, x2: y2] denotes a set of tones with indices k satisfying x1≤k≤y1 or x2≤k≤y2.

Optionally, for the 26-tone RU 4 to the 26-tone RU 6, the tone indices for which the coefficients are non-zero under rRU and the tone indices for which the coefficients are non-zero under dRU may be as illustrated in Table 2.

TABLE 2

| RU | rRU tone | dRU tone |
|---|---|---|
| index | indices | indices |
| RU 4 | [−42:−17] | [−118, −109, −100, −91, −82, −73, −63, −54, −45, −36, −27, |
| | | −18, −9, 7, 16, 25, 34, 43, 52, 61, 71, 80, 89, 98, 107, 116] |
| RU 5 | [−16:−4, | [−117, −108, −99, −90, −81, −72, −62, −53, −44, −35, −26, |
| | 4:16] | −17, −8, 8, 17, 26, 35, 44, 53, 62, 72, 81, 90, 99, 108, 117] |
| RU 6 | [17:42] | [−116, −107, −98, −89, −80, −71, −61, −52, −43, −34, −25, |
| | | −16, −7, 9, 18, 27, 36, 45, 54, 63, 73, 82, 91, 100, 109, |
| | | 118] |

Optionally, Table 2 may be adjusted to Table 3 in consideration of the requirement of the first rule that each dRU in the tone plan includes tone index(es) for which one or more coefficients in the first sequence are non-zero.

TABLE 3

| RU | rRU tone | dRU tone |
|---|---|---|
| index | indices | indices |
| RU 4 | [−42:−17] | [−118, −109, −100, −91, −82, −73, −63, −54, −45, −36, −27, |
| | | −18, −9, 7, 17, 25, 34, 43, 52, 61, 71, 80, 89, 98, 107, 116] |
| RU 5 | [−16:−4, | [−117, −108, −99, −90, −81, −72, −62, −53, −44, −35, −26, |
| | 4:16] | −16, −8, 8, 16, 26, 35, 44, 53, 62, 72, 81, 90, 99, 108, 117] |
| RU 6 | [17:42] | [−116, −107, −98, −89, −80, −71, −61, −52, −43, −34, −25, |
| | | −17, −7, 9, 18, 27, 36, 45, 54, 63, 73, 82, 91, 100, 109, |
| | | 118] |

The underlined tone indices in Table 2 may be adjusted to the underlined tone indices in Table 3. As illustrated in Table 3, the intervals of the adjusted nonzero tone indices are no longer 9. Specifically, for the fifteenth tone (with index “17”) in dRU 4, the twelfth tone (with index “−16”) in dRU 5, the fifteenth tone (with index “16”) in dRU 5, and the twelfth tone (with index “−17”) in dRU 6, the intervals between these tone indices and their adjacent tone indices are no longer 9.

In order to facilitate understanding, First embodiment will be described in detail below with reference to Embodiment 1.1 and by taking a 20 MHz UHR MU PPDU as an example.

### Embodiment 1.1

When a 20 MHz UHR MU PPDU is transmitted using dRU, the UHR-STF sequence shall follow the specifications for the 20 MHz EHT MU PPDU in the above section “EHT-STF”. Exemplarily, the indices for the 26-tone rRU and 26-tone dRU in the 20 MHz UHR MU PPDU may be as illustrated in Table 4.

For example, an AP transmits a 20 MHz UHR MU PPDU, and there are a total of eight STAs, which are assigned dRU 1 to dRU 4 and dRU 6 to dRU 9, respectively. Since dRU 5 is an unassigned dRU, the values (or coefficients) on tones indices −16 and 16 in the UHR-STF are set to 0.

TABLE 4

| | | | Tone indices | | Tone indices |
|---|---|---|---|---|---|
| | | rRU | in rRU | | in dRU |
| RU | RU | tone | corresponding | dRU tone | corresponding |
| size | index | indices | to UHR-STF | indices | to UHR-STF |
| 26- | RU 1 | [−121:−96] | −112, −96 | [−121, −112, −103, −94, −85, −76, | −112, −48 |
| tone | | | | −66, −57, −48, −39, −30, −21, −12, 4, | |
| RU | | | | 13, 22, 31, 40, 49, 58, 67, 77, 86, | |
| | | | | 95, 104, 113] | |
| | RU 2 | [−95:−70] | −80 | [−120, −111, −102, −93, −84, −75, | 32, 96 |
| | | | | −65, −56, −47, −38, −29, −20, −11, 5, | |
| | | | | 14, 23, 32, 41, 50, 59, 68, 78, 87, | |
| | | | | 96, 105, 114] | |
| | RU 3 | [−68:−43] | −64, −48 | [−119, −110, −101, −92, −83, −74, | −64 |
| | | | | −64, −55, −46, −37, −28, −19, −10, 6, | |
| | | | | 15, 24, 33, 42, 51, 60, 70, 79, 88, | |
| | | | | 97, 106, 115] | |
| | RU 4 | [−42:−17] | −32 | [−118, −109, −100, −91, −82, −73, | 80 |
| | | | | −63, −54, −45, −36, −27, −18, −9, 7, | |
| | | | | 17, 25, 34, 43, 52, 61, 71, 80, 89, | |
| | | | | 98, 107, 116] | |
| | RU 5 | [−16:−4, | −16, 16 | [−117, −108, −99, −90, −81, −72, −62, | −16, 16 |
| | | 4:16] | | −53, −44, −35, −26, −16, −8, 8, 16, | |
| | | | | 26, 35, 44, 53, 62, 72, 81, 90, 99, | |
| | | | | 108, 117] | |
| | RU 6 | [17:42] | 32 | [−116, −107, −98, −89, −80, −71, −61, | −80 |
| | | | | −52, −43, −34, −25, −17, −7, 9, 18, | |
| | | | | 27, 36, 45, 54, 63, 73, 82, 91, 100, | |
| | | | | 109, 118] | |
| | RU 7 | [43:68] | 48, 64 | [−115, −106, −97, −88, −79, −70, −60, | 64 |
| | | | | −51, −42, −33, −24, −15, −6, 10, 19, | |
| | | | | 28, 37, 46, 55, 64, 74, 83, 92, 101, | |
| | | | | 110, 119] | |
| | RU 8 | [70:95] | 80 | [−114, −105, −96, −87, −78, −68, −59, | −96, −32 |
| | | | | −50, −41, −32, −23, −14, −5, | |
| | | | | 11, 20, 29, 38, 47, 56, 65, 75, 84, | |
| | | | | 93, 102, 111, 120] | |
| | RU 9 | [96:121] | 96, 112 | [−113, −104, −95, −86, −77, −67, −58, | 48, 112 |
| | | | | −49, −40, −31, −22, −13, −4, 12, 21, | |
| | | | | 30, 39, 48, 57, 66, 76, 85, 94, 103, | |
| | | | | 112, 121] | |

### Second Embodiment

In some implementations, when the first PPDU is a non-trigger-based PPDU or a trigger-based PPDU, the first rule may include that: the first sequence is determined based on a frequency domain sequence of the first field when the trigger-based PPDU is transmitted using rRU. That is to say, regardless of whether the first PPDU is the trigger-based PPDU or not, the first sequence may be determined based on the frequency domain sequence of the first field when the trigger-based PPDU is transmitted using rRU.

The frequency domain sequence of the first field in the trigger-based PPDU is generally longer than the frequency domain sequence of the first field in the non-trigger-based PPDU, i.e., there are more tones for which the coefficients are non-zero. Therefore, the first rule in Second embodiment may enable a dRU to include more nonzero tone indices, or enable each dRU to include nonzero tone index(es). Moreover, this solution can reuse related technologies, so the implementation complexity is low. In addition, since the first sequence may not be considered when designing the tone plan of the dRU, the tone plan is simpler.

The non-trigger-based PPDU may include a UHR MU PPDU. The trigger-based PPDU may include a UHR TB PPDU, an EHT TB PPDU.

For example, when the UHR MU PPDU or the UHR TB PPDU is transmitted using dRU, the definitions of the UHR-STF sequences for 20 MHz, 40 MHz, 80 MHz, 160 MHz, and 320 MHz may be determined according to the EHT-STF sequences used by the EHT TB PPDU for 20 MHz, 40 MHz, 80 MHz, 160 MHz, and 320 MHz, respectively.

As can be seen from the above, the EHT-STF sequence of the EHT TB PPDU is longer than the EHT-STF sequence of the EHT MU PPDU, that is, there are more tones for which the coefficients are non-zero. Therefore, the first rule in Second embodiment may enable more tone indices for which the coefficients in the EHT-STF sequence are non-zero to overlap with the dRU tone indices. For example, it may be achieved that each dRU includes tone(s) corresponding to nonzero tone index(es).

In order to facilitate understanding, Second embodiment will be described in detail below with reference to Embodiment 2.1 and by taking a 20 MHz UHR TB PPDU as an example.

### Embodiment 2.1

When a 20 MHz UHR TB PPDU is transmitted using dRU, the UHR-STF sequence shall follow the specifications for the 20 MHz EHT TB PPDU in the above section “EHT-STF”. The indices for the 26-tone rRU and 26-tone dRU in the 20 MHz UHR TB PPDU may be illustrated in Table 5.

For example, an AP requests a 20 MHz UHR TB PPDU, and there are a total of nine STAs, which are assigned dRU 1 to dRU 9, respectively. For each STA, when transmitting the UHR TB PPDU, the STA transmits the UHR-STF only on the indices of the tones within its assigned dRU.

TABLE 5

| | | | Tone indices | | Tone indices |
|---|---|---|---|---|---|
| | | | in rRU | | in dRU |
| RU | RU | rRU tone | corresponding | dRU tone | corresponding |
| size | index | indices | to UHR-STF | indices | to UHR-STF |
| 26- | RU 1 | [−121:−96] | −120, −112, | [−121, −112, −103, −94, −85, | −112, −48, |
| tone | | | −104, −96 | −76, −66, −57, −48, −39, −30, −21, | 40, 104 |
| RU | | | | −12, 4, 13, 22, 31, 40, 49, 58, | |
| | | | | 67, 77, 86, 95, 104, 113] | |
| | RU 2 | [−95:−70] | −88, −80, | [−120, −111, −102, −93, −84, −75, | −120, −56, |
| | | | −72 | −65, −56, −47, −38, −29, −20, −11, | 32, 96 |
| | | | | 5, 14, 23, 32, 41, 50, 59, 68, | |
| | | | | 78, 87, 96, 105, 114] | |
| | RU 3 | [−68:−43] | −64, −56, | [−119, −110, −101, −92, −83, −74, | −64, 24, |
| | | | −48 | −64, −55, −46, −37, −28, −19, −10, | 88 |
| | | | | 6, 15, 24, 33, 42, 51, 60, 70, | |
| | | | | 79, 88, 97, 106, 115] | |
| | RU 4 | [−42:−17] | −40, −32, | [−118, −109, −100, −91, −82, −73, | 16, 80 |
| | | | −24 | −63, −54, −45, −36, −27, −18, −9, | |
| | | | | 7, 16, 25, 34, 43, 52, 61, 71, | |
| | | | | 80, 89, 98, 107, 116] | |
| | RU 5 | [−16:−4, | −16, −8, | [−117, −108, −99, −90, −81, −72, | −72, −8, |
| | | 4:16] | 8, 16 | −62, −53, −44, −35, −26, −17, −8, | 8, 72 |
| | | | | 8, 17, 26, 35, 44, 53, 62, 72, | |
| | | | | 81, 90, 99, 108, 117] | |
| | RU 6 | [17:42] | 24, 32, | [−116, −107, −98, −89, −80, −71, | −80, −16 |
| | | | 40 | −61, −52, −43, −34, −25, −16, −7, | |
| | | | | 9, 18, 27, 36, 45, 54, 63, 73, | |
| | | | | 82, 91, 100, 109, 118] | |
| | RU 7 | [43:68] | 48, 56, | [−115, −106, −97, −88, −79, −70, | −88, −24, |
| | | | 64 | −60, −51, −42, −33, −24, −15, −6, | 64 |
| | | | | 10, 19, 28, 37, 46, 55, 64, 74, | |
| | | | | 83, 92, 101, 110, 119] | |
| | RU 8 | [70:95] | 72, 80, | [−114, −105, −96, −87, −78, −68, | −96, −32, |
| | | | 88 | −59, −50, −41, −32, −23, −14, −5, | 56, 120 |
| | | | | 11, 20, 29, 38, 47, 56, 65, 75, | |
| | | | | 84, 93, 102, 111, 120] | |
| | RU 9 | [96:121] | 96, 104, | [−113, −104, −95, −86, −77, −67, | −104, −40, |
| | | | 112, 120 | −58, −49, −40, −31, −22, −13, −4, | 48, 112 |
| | | | | 12, 21, 30, 39, 48, 57, 66, 76, | |
| | | | | 85, 94, 103, 112, 121] | |

### Third Embodiment

In Third embodiment, the first sequence may be newly defined. For example, the first sequence may be designed based on the tone plan of the dRU.

Optionally, the first rule may include that: coefficients, on every N tone indices, in the first sequence are non-zero. Here, N is less than or equal to a first threshold, and the N and the first threshold are both positive integers. That is, for the case of dRU, in the first sequence, the interval between tone indices for which the coefficients are non-zero may be smaller (less than the first threshold). That is, there should be as many tones (for which the coefficients are non-zero) in the first sequence as possible. Therefore, the first rule in Third embodiment may enable a dRU to include more nonzero tone indices, so as to avoid the situation in which the dRU excludes the tone corresponding to the nonzero tone index.

As a possible implementation, the first threshold may be less than or equal to 4. Taking the first threshold value being 4 as an example, N may be 4, that is, in the first sequence, the coefficients on every N tone indices may be non-zero.

For example, when a 20 MHz UHR TB PPDU or a 20 MHz UHR MU PPDU is transmitted using dRU, the UHR-STF sequence may satisfy:

$$[ {UHRS}_{- 1 \; 20 : 4 : 120}^{dRU} = \{ M , - M , 0 , M , - M \} \cdot \frac{1 + j}{\sqrt{2}} .$$

Here, M can satisfy: M={−1, −1, −1, 1, 1, 1, −1, 1, 1, 1, −1, 1, 1, −1, 1}. The value at the null tone index 0 is UHRS₀=0.

It should be noted that for the First, Second and Third embodiments above-described, the first sequence may be a frequency domain sequence obtained by phase rotation. The phase rotation may include, for example, multiplying the frequency domain sequence by +1, −1, +j, or −j. After the phase rotation, the peak to average power ratio (PAPR) of the frequency domain sequence in dRU mode can be low.

In the foregoing, the first rule related to the first sequence has been described with reference to the First, Second, and Third embodiments. Hereinafter, the first rule related to second sequence will be described with reference to Fourth embodiment.

### Fourth Embodiment

In some implementations, the second sequence may be determined based on a frequency domain sequence of the second field when the first PPDU is transmitted using rRU.

As a possible implementation, the second sequence may be the frequency domain sequence of the second field when the first PPDU is transmitted using rRU. That is to say, for the second field under dRU, it may be consistent with the frequency domain sequence of the second field under rRU. This implementation can reuse the frequency domain sequence in related technologies, so it has low complexity and is easy to implement.

In some implementations, the first rule may include that: the second sequence may be determined based on the frequency domain sequence of the second field in the related technologies. Exemplarily, when the second sequence is a frequency domain sequence of the UHR-LTF under dRU, the second sequence may be the same as the EHT-LTF sequence. Here, for the EHT-LTF sequence, the reference may be made to the above descriptions.

For example, when the UHR PPDU is transmitted using dRU, the definitions of the UHR-LTF sequences for 20 MHz, 40 MHz, 80 MHz, 160 MHz, and 320 MHz may be the same as the definitions of the EHT-LTF sequences used by the EHT PPDU for 20 MHZ, 40 MHz, 80 MHz, 160 MHz, and 320 MHz, respectively.

Exemplarily, when the UHR PPDU is transmitted using dRU, the definition of the UHR-LTF sequence may be the same as that of at least one of: 1x EHT-LTF, 2x EHT-LTF, or 4x EHT-LTF.

Exemplarily, when the UHR PPDU is transmitted using dRU, only 4x EHT-LTF or 2x EHT-LTF can be used. The 4x EHT-LTF or the 2x EHT-LTF has a longer frequency domain sequence of the second field than the 1x EHT-LTF, i.e., there are more tones for which coefficients are non-zero. Therefore, this implementation may enable a dRU to include more nonzero tone indices.

As another possible implementation, the second sequence may be a frequency domain sequence obtained by performing phase rotation on the frequency domain sequence of the second field when the first PPDU is transmitted using rRU. The phase rotation may include, for example, multiplying the frequency domain sequence by +1, −1, +j, or −j.

For example, when the UHR PPDU is transmitted using dRU, the definitions of the UHR-LTF sequences for 20 MHz, 40 MHz, 80 MHz, 160 MHz, and 320 MHz may be obtained by performing phase rotation on the EHT-LTF sequences used by the EHT PPDU for 20 MHz, 40 MHz, 80 MHz, 160 MHz, and 320 MHz, respectively.

In order to facilitate understanding, Fourth embodiment will be described in detail below with reference to Embodiment 4.1 and by taking a 20 MHz UHR TB PPDU as an example.

### Embodiment 4.1

When a 20 MHz UHR TB PPDU is transmitted using dRU, the UHR-LTF sequence shall follow the specifications for the 20 MHz EHT TB PPDU in the above section “EHT-LTF”. The indices for the 26-tone rRU and 26-tone dRU in the 20 MHz UHR TB PPDU can be illustrated in Table 6.

For example, an AP requests a 20 MHz UHR TB PPDU, and there are a total of eight STAs, which are assigned dRU 1 to dRU 4 and dRU 6 to dRU 9, respectively. For each STA, when transmitting the UHR TB PPDU, the STA transmits the UHR-LTF only on the indices of the tones within the dRU to which the STA is assigned, as illustrated in the last column of Table 6. dRU 5 is an unassigned dRU, so the values (or coefficients) on tone indices −108, −72, −44, −8, 8, 44, 72, 108 in the UHR-LTF are set to 0.

TABLE 6

| | | | tone indices | | Tone indices |
|---|---|---|---|---|---|
| | | | in rRU | | in dRU |
| RU | RU | rRU tone | corresponding | dRU tone | corresponding |
| size | index | indices | to UHR-LTF | indices | to UHR-LTF |
| 26- | RU 1 | [−121:−96] | −120, −116, | [−121, −112, −103, −94, −85, −76, | −112, −76, |
| tone | | | −112, −108, | −66, −57, −48, −39, −30, −21, −12, | −48, −12, 4, |
| RU | | | −104, −100, −96 | 4, 13, 22, 31, 40, 49, 58, 67, 77, | 40, 104 |
| | | | | 86, 95, 104, 113] | |
| | RU 2 | [−95:−70] | −92, −88, −84, | [−120, −111, −102, −93, −84, −75, | −120, −56, |
| | | | −80, −76, −72 | −65, −56, −47, −38, −29, −20, −11, | −20, 32, |
| | | | | 5, 14, 23, 32, 41, 50, 59, 68, 78, | 68, 96 |
| | | | | 87, 96, 105, 114] | |
| | RU 3 | [−68:−43] | −68, −64, −60, | [−119, −110, −101, −92, −83, −74, | −92, −64, −28, |
| | | | −56, −52, −48, | −64, −55, −46, −37, −28, −19, −10, | 24, 60, 88 |
| | | | −44 | 6, 15, 24, 33, 42, 51, 60, 70, 79, | |
| | | | | 88, 97, 106, 115] | |
| | RU 4 | [−42:−17] | −40, −36, −32, | [−118, −109, −100, −91, −82, −73, | −100, −36, 16, |
| | | | −28, −24, −20, | −63, −54, −45, −36, −27, −18, −9, | 52, 80, 116 |
| | | | −16 | 7, 16, 25, 34, 43, 52, 61, 71, 80, | |
| | | | | 89, 98, 107, 116] | |
| | RU 5 | [−16:−4, | −12, −8, −4, | [−117, −108, −99, −90, −81, −72, | −108, −72, |
| | | 4:16] | 4, 8, 12, 16 | −62, −53, −44, −35, −26, −17, −8, 8, | −44, −8, 8, |
| | | | | 17, 26, 35, 44, 53, 62, 72, 81, | 44, 72, 108 |
| | | | | 90, 99, 108, 117] | |
| | RU 6 | [17:42] | 20, 24, 28, | [−116, −107, −98, −89, −80, −71, | −116, −80, |
| | | | 32, 36, 40 | −61, −52, −43, −34, −25, −16, −7, 9, | −52, −16, 36, |
| | | | | 18, 27, 36, 45, 54, 63, 73, 82, | 100 |
| | | | | 91, 100, 109, 118] | |
| | RU 7 | [43:68] | 44, 48, 52, | [−115, −106, −97, −88, −79, −70, | −88, −60, −24, |
| | | | 56, 60, 64, 68 | −60, −51, −42, −33, −24, −15, −6, | 28, 64, 92 |
| | | | | 10, 19, 28, 37, 46, 55, 64, 74, | |
| | | | | 83, 92, 101, 110, 119] | |
| | RU 8 | [70:95] | 72, 76, 80, | [−114, −105, −96, −87, −78, −68, | −96, −68, −32, |
| | | | 84, 88, 92 | −59, −50, −41, −32, −23, −14, −5, | 20, 56, 84, |
| | | | | 11, 20, 29, 38, 47, 56, 65, 75, | 120 |
| | | | | 84, 93, 102, 111, 120] | |
| | RU 9 | [96:121] | 96, 100, 104, | [−113, −104, −95, −86, −77, −67, | −104, −4, 12, |
| | | | 108, 112, 116, | −58, −49, −40, −31, −22, −13, −4, | 48, 76, 112 |
| | | | 120 | 12, 21, 30, 39, 48, 57, 66, 76, | |
| | | | | 85, 94, 103, 112, 121] | |

It should be noted that the First, Second, Third and Fourth embodiments may be implemented separately or in combination, and the present disclosure is not limited thereto.

Hereinafter, the first rule related to the PE field will be described.

In some embodiments, the first rule may include that: the PE field is transmitted on a dRU occupied by a data field of the first PPDU. For example, the first device transmits the PE field in a dRU or dMRU occupied by the data field.

In some implementations, the first rule may include that: the spectrum used by the PE field may be commensurate with locations of tones in the dRU or dMRU occupied by the data field; and/or the spectrum used by the PE field is commensurate with sizes of the dRU or dMRU occupied by the data field.

In some implementations, the first rule may include that: a transmission power of the PE field may be determined based on an average transmission power of the data field. For example, the PE field may be transmitted using the same average power as the data field.

The following description takes an example where the first PPDU is a 20 MHz UHR TB PPD. For example, an AP requests transmission of a 20 MHz UHR TB PPDU, and there are eight STAs, which are assigned 26-tone dRU 1 to 26-tone dRU 4 and 26-tone dRU 6 to 26-tone dRU 9, respectively. For each STA, when transmitting the UHR TB PPDU, the STA may transmit the PE field in its assigned dRU.

In some embodiments, an indication field may be used to indicate whether the first PPDU is transmitted using dRU. Alternatively, the indication field may be used to indicate a type of a RU of the first PPDU. Types of RUs may include rRU and dRU. Therefore, the indication field may also be referred to as a “RU type” field.

Optionally, the indication field may include, for example, a first indication field. The first PPDU may include the first indication field. The first indication field may be used to indicate whether the current PPDU (i.e., the first PPDU) is transmitted using dRU.

In some implementations, the first indication field may have 1 bit. For example, a value of the first indication field is 0, it may indicate that the first PPDU is transmitted using rRU or rMRU, or indicate that the RU indicated by the RU allocation field is rRU or rMRU. For another example, the value of the first indication field is 1, it may indicate that the first PPDU is transmitted using rRU or rMRU, or indicate that the RU indicated by the RU allocation field is rRU or rMRU. For another example, the value of the first indication field is 0, it may indicate that the first PPDU is transmitted using dRU or dMRU, or indicate that the RU indicated by the RU allocation field is dRU or dMRU. For another example, the value of the first indication field is 1, it may indicate that the first PPDU is transmitted using dRU or dMRU, or indicate that the RU indicated by the RU allocation field is dRU or dMRU.

The first indication field may belong to one or more of: a U-SIG field, or a UHR-SIG field.

Optionally, the indication field may include a second indication field. The second indication field may be located in a trigger frame corresponding to the first PPDU. That is to say, the second indication field may be used to indicate whether the PPDU (i.e., the first PPDU) triggered by the current trigger frame is transmitted via the dRU.

In some implementations, the second indication field may have 1 bit. For example, a value of the second indication field is 0, it may indicate that the first PPDU is transmitted using rRU or rMRU; or indicate that the RU indicated jointly by the RU allocation subfield in the UHR variant User Info field, the UL BW subfield in the Common Info field, and the UL BW Extension subfield in the Special User Info field is rRU or rMRU. For another example, the value of the second indication field is 1, it may indicate that the first PPDU is transmitted using rRU or rMRU; or indicate that the RU indicated jointly by the RU allocation subfield in the UHR variant User Info field, the UL BW subfield in the Common Info field, and the UL BW Extension subfield in the Special User Info field is rRU or rMRU. For another example, the value of the second indication field is 0, it may indicate that the first PPDU is transmitted using dRU or dMRU; or indicate that the RU indicated jointly by the RU allocation subfield in the UHR variant User Info field, the UL BW subfield in the Common Info field, and the UL BW Extension subfield in the Special User Info field is dRU or dMRU. For another example, the value of the second indication field is 1, it may indicate that the first PPDU is transmitted using dRU or dMRU; or indicate that the RU indicated jointly by the RU allocation subfield in the UHR variant User Info field, the UL BW subfield in the Common Info field, and the UL BW Extension subfield in the Special User Info field is dRU or dMRU.

The method embodiments of the present disclosure have been described in detail above, and device embodiments of the present disclosure will be described in detail below. It should be understood that the description of the method embodiments and the description of the device embodiments correspond to each other. Therefore, for the portions not described in detail, the reference may be made to the foregoing method embodiments.

FIG. 6 is a structural diagram of a communication device 600 according to an embodiment of the present disclosure. The communication device 600 may include a transmitting unit 610.

The transmitting unit 610 is configured to transmit a first PPDU. Here, the first PPDU includes a preamble and/or a PE field; and when the first PPDU is transmitted using a dRU, tones occupied by the preamble and/or the PE field satisfy a first rule.

In an alternative embodiment, the transmitting unit 610 may be a transceiver 830. The communication device 600 may also include a processor 810 and a memory 820, as specifically illustrated in FIG. 8.

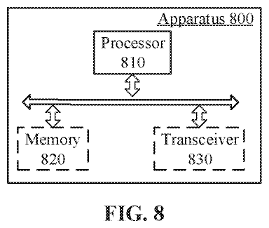

FIG. 7 is a structural diagram of a communication device 700 according to an embodiment of the present disclosure. The communication device 700 may include a receiving unit 710.

The receiving unit 710 is configured to receive a first PPDU. Here, the first PPDU includes a preamble and/or a PE field; and when the first PPDU is transmitted using a dRU, tones occupied by the preamble and/or the PE field satisfy the first rule.

In an alternative embodiment, the receiving unit 710 may be a transceiver 830. The communication device 700 may also include a processor 810 and a memory 820, as specifically illustrated in FIG. 8.

FIG. 8 is a structural diagram of an apparatus for communication according to an embodiment of the present disclosure. The dashed line in FIG. 8 indicates that the unit or module is optional. The apparatus 800 may be used to implement the methods described in the method embodiments described above. The apparatus 800 may be a chip or a communication device.

The apparatus 800 may include one or more processors 810. The processor 810 may support the apparatus 800 to implement the methods described in the above method embodiments. The processor 810 may be a general-purpose processor or a special-purpose processor. For example, the processor may be a central processing unit (CPU). Alternatively, the processor may also be another general purpose processor, a digital signal processor (DSP), an application specific integrated circuit (ASIC), a field programmable gate array (FPGA) or another programmable logic device, a discrete gate or transistor logic device, a discrete hardware component, or the like. The general purpose processor may be a microprocessor or the processor may be any conventional processor or the like.

The apparatus 800 may also include one or more memories 820. The memory 820 has a program stored thereon that can be executed by the processor 810 to cause the processor 810 to perform the methods described in the foregoing method embodiments. The memory 820 may be independent of the processor 810 or may be integrated in the processor 810.

The apparatus 800 may also include a transceiver 830. The processor 810 may communicate with other devices or chips via the transceiver 830. For example, the processor 810 may transmit and receive data with other devices or chips via the transceiver 830.

The embodiments of the present disclosure further provide a computer-readable storage medium for storing a program. The computer-readable storage medium can be applied to the communication device provided by the embodiments of the present disclosure, and the program causes a computer to execute the methods executed by the communication device in the respective embodiments of the present disclosure.

The embodiments of the present disclosure further provide a computer program product. The computer program product includes a program. The computer program product can be applied to the communication device provided by the embodiments of the present disclosure, and the program causes a computer to execute the methods executed by the communication device in the respective embodiments of the present disclosure.

The embodiments of the present disclosure further provide a computer program. The computer program can be applied to the communication device provided by the embodiments of the present disclosure, and the computer program causes a computer to execute the methods executed by the communication device in the respective embodiments of the present disclosure.

It is to be understood that the terms “system” and “network” may be used interchangeably in the present disclosure. In addition, the terminology used in the present disclosure is only for explanation of specific embodiments of the present disclosure, and is not intended to limit the present disclosure. The terms “first,” “second,” “third,” and “fourth,” and the like in the specification and claims of the present disclosure and the accompanying drawings are used to distinguish different objects, and are not used to describe a specific order. Furthermore, the terms “including/comprising” and “having” and any variations thereof are intended to cover non-exclusive inclusions.

In the embodiments of the present disclosure, the “field” may also be referred to as a “subfield”. A field may occupy one or more bytes/octets, or a field may occupy one or more bits.

In the embodiments of the present disclosure, the “indication/indicating/indicate” mentioned may be a direct indication, an indirect indication, or an association relationship. For example, A indicates B, which may mean that A directly indicates B, for example, B can be obtained through A; or mean that A indicates B indirectly, for example, A indicates C, and B can be obtained through C; or mean that there is an association relationship between A and B.

In the embodiments of the present disclosure, “B corresponding to A” means that B is associated with A, and B can be determined from A. However, it should also be understood that determining B from A does not mean that B is determined from A alone, it may also be that B is determined from A and/or other information.

In the embodiments of the present disclosure, the term “correspondence/corresponding/correspond” may indicate that there is a direct correspondence or indirect correspondence relationship between the two, or may indicate that there is an association relationship between the two, or may indicate a relationship between indicating and being indicated, configuring and being configured, or the like.

In the embodiments of the present disclosure, “predefined/predefinition” or “preconfigured/pre-configuration” may be realized by pre-storing corresponding codes, tables, or other means that can be used to indicate relevant information in a device (including, for example, AP and STA), and the present disclosure does not limit the specific implementation thereof. For example, predefinition may refer to being defined in the protocol.

The term “and/or” in the embodiments of the present disclosure is only an association relationship describing associated objects, and indicates that there may be three kinds of relationships. For example, A and/or B, which may indicate that A exists alone, A and B exist simultaneously, and B exists alone. In addition, the character “/” in this article generally indicates that the related objects before and after the character are in an “or” relationship.

In the embodiments of the present disclosure, “including/include/comprising/comprise” may refer to directly including or indirectly including. Alternatively, “including/include/comprising/comprise” mentioned in the embodiments of the present disclosure may be replaced with “indicating/indicate” or “for determining”. For example, “A includes B” can be replaced with “A indicates B”, or “A is used for determining B”.

In various embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure.

In the embodiments of the present disclosure, the “protocol” may refer to a standard protocol in the field of communications, and may include, for example, a WiFi protocol and related protocols applied to a future WiFi communication system, which are not limited in the present disclosure.

In several embodiments provided by the present disclosure, it should be understood that the disclosed systems, apparatuses, and methods may be implemented in other ways. For example, the device embodiments described above are merely schematic, for example, the division of units is only a logical function division, and there may be other division methods in actual implementation, for example, multiple units or components may be combined or integrated into another system, or some features may be ignored or not executed. In addition, the coupling or direct coupling or communication connection between each other shown or discussed may be indirect coupling or communication connection through some interfaces, devices or units, which may be electrical, mechanical or other forms.

The units described as separate components may or may not be physically separate, and the components displayed as units may or may not be physical units, that is, they may be located in one place or may be distributed over multiple network units. Some or all of the units may be selected according to actual needs to implement the purpose of the solutions of the embodiments.

In addition, the functional units in the embodiments of the present disclosure may be integrated in one processing unit, or each unit may be physically present alone, or two or more units may be integrated in one unit.

The embodiments described above may be implemented in whole or in part by software, hardware, firmware, or any combination thereof. When implemented using software, the embodiments may be implemented in whole or in part in the form of a computer program product. The computer program product includes one or more computer instructions. The computer program instructions, when are loaded and executed on a computer, cause the computer to generate, in whole or in part, the processes or functions described in accordance with embodiments of the present disclosure. The computer may be a general purpose computer, a special purpose computer, a computer network, or other programmable device. The computer instructions may be stored in a computer-readable storage medium or transmitted from one computer-readable storage medium to another computer-readable storage medium, for example, the computer instructions may be transmitted from one website site, computer, server, or data center by wired (e.g., coaxial cable, optical fiber, digital subscriber line (DSL)) or wireless (e.g., infrared, wireless, microwave) means to another website site, computer, server, or data center. The computer-readable storage medium can be any available medium accessible by a computer, or a data storage device (e.g., a server or a data center) incorporating one or more available media. The available media may be magnetic media (e.g., floppy disk, hard disk, magnetic tape), optical media (e.g., digital video disc (DVD)), or semiconductor media (e.g., solid state disk (SSD)), or the like.

The above is merely specific embodiments of the present disclosure, but the scope of protection of the present disclosure is not limited thereto. Any change or substitution that can be readily conceived by a person skilled in the art within the technical scope disclosed in the present disclosure shall be covered within the protection scope of the present disclosure. Therefore, the scope of protection of the present disclosure should be subject to the scope of protection of the claims.

1. A wireless communication method, comprising:
transmitting, by a first device, a first physical layer protocol data unit (PPDU);
wherein the first PPDU comprises a preamble and/or a packet extension (PE) field, and
in a case that the first PPDU is transmitted using a distributed resource unit (dRU), tones occupied by the preamble and/or the PE field satisfy a first rule.

2. The method of claim 1, wherein the preamble comprises a first field, wherein
the first field is related to automatic gain control estimation in multiple-input multiple-output (MIMO) transmission, and
a frequency domain sequence of the first field is a first sequence, the first sequence satisfying the first rule.

3. The method of claim 2, wherein the first rule comprises:
the first sequence is determined based on a frequency domain sequence of the first filed when the first PPDU is transmitted using a regular resource unit (rRU).

4. The method of claim 3, wherein the first rule comprises:
the first sequence is the frequency domain sequence of the first field when the first PPDU is transmitted using the rRU.

5. The method of claim 2, wherein the first field is an ultra-high reliability short training field (UHR-STF).

6. The method of claim 5, wherein in a case that the first sequence is a frequency domain sequence of the UHR-STF for dRU, the first rule comprises:
the first sequence is the same as an extremely high throughput short training field (EHT-STF) sequence.

7. The method of claim 6, wherein the first PPDU is a UHR trigger-based (TB) PPDU, and in a case that the UHR TB PPDU is transmitted using the dRU, the first rule comprises:
the first sequence for each of 20 MHz, 40 MHz, 80 MHz, 160 MHz, and 320 MHz is the same as an EHT-STF sequence used by an EHT TB PPDU for each of 20 MHz, 40 MHZ, 80 MHz, 160 MHz, and 320 MHz, respectively.

8. The method of claim 1, wherein the first rule comprises:
the PE field is transmitted on a dRU or a distributed multiple-resource unit (dMRU) occupied by a data field of the first PPDU.

9. The method of claim 8, wherein the first rule comprises:
a spectrum used by the PE field is commensurate with locations of tones in the dRU or the dMRU occupied by the data field; and/or,
the spectrum used by the PE field is commensurate with sizes of the dRU or the dMRU occupied by the data field.

10. A communication device, the communication device being a first device, the communication device comprising:
a processor; and
a memory for storing one or more computer programs that, when executed by the processor, cause the communication device to transmit a first physical layer protocol data unit (PPDU);
wherein the first PPDU comprises a preamble and/or a packet extension (PE) field, and
in a case that the first PPDU is transmitted using a distributed resource unit (dRU), tones occupied by the preamble and/or the PE field satisfy a first rule.

11. The device of claim 10, wherein the preamble comprises a pre-modulated field, and the first rule comprises that the pre-modulated field is transmitted using contiguous tones.

12. The device of claim 10, wherein the preamble comprises a first field, wherein
the first field is related to automatic gain control estimation in multiple-input multiple-output (MIMO) transmission, and
a frequency domain sequence of the first field is a first sequence, the first sequence satisfying the first rule.

13. The device of claim 12, wherein the first rule comprises:
the first sequence is determined based on a frequency domain sequence of the first filed when the first PPDU is transmitted using a regular resource unit (rRU).

14. The device of claim 13, wherein the first rule comprises:
the first sequence is the frequency domain sequence of the first field when the first PPDU is transmitted using the rRU.

15. The device of claim 12, wherein the first field is an ultra-high reliability short training field (UHR-STF).

16. The device of claim 15, wherein in a case that the first sequence is a frequency domain sequence of the UHR-STF for dRU, the first rule comprises:
the first sequence is the same as an extremely high throughput short training field (EHT-STF) sequence.

17. The device of claim 16, wherein the first PPDU is a UHR trigger-based (TB) PPDU, and in a case that the UHR TB PPDU is transmitted using the dRU, the first rule comprises:
the first sequence for each of 20 MHz, 40 MHz, 80 MHZ, 160 MHz, and 320 MHz is the same as an EHT-STF sequence used by an EHT TB PPDU for each of 20 MHz, 40 MHZ, 80 MHz, 160 MHz, and 320 MHz, respectively.

18. The device of claim 10, wherein the first rule comprises:
the PE field is transmitted on a dRU or a distributed multiple-resource unit (dMRU) occupied by a data field of the first PPDU.

19. The device of claim 18, wherein the first rule comprises:
a spectrum used by the PE field is commensurate with locations of tones in the dRU or the dMRU occupied by the data field; and/or,
the spectrum used by the PE field is commensurate with sizes of the dRU or the dMRU occupied by the data field.

20. The device of claim 10, wherein the first PPDU comprises a first indication field, the first indication field being used for indicating whether the first PPDU is transmitted using the dRU; or
wherein a trigger frame corresponding to the first PPDU comprises a second indication field, the second indication field being used for indicating whether the first PPDU is transmitted using the dRU.
